(19) United States
(12) Patent Application Publication
(10) Pub. No.: US 2014/0063288 A1
(43) Pub. Date: Mar. 6, 2014

(54) IMAGING APPARATUS, ELECTRONIC DEVICE AND METHOD PROVIDING EXPOSURE COMPENSATION

(71) Applicant: Pantech Co., Ltd., Seoul (KR)

(72) Inventors: Young-Bae SUH, Seoul (KR); Jae-Man Hong, Seoul (KR)

(73) Assignee: Pantech Co., Ltd., Seoul (KR)

(21) Appl. No.: 14/012,691

(22) Filed: Aug. 28, 2013

(30) Foreign Application Priority Data
Aug. 30, 2012 (KR) 10-2012-0095890
Feb. 26, 2013 (KR) 10-2013-0020702

(51) Int. Cl. H04N 5/235

(52) U.S. Cl. CPC H04N 5/2353
USPC 348/229.1

(57) ABSTRACT

There are provided an imaging apparatus and an electronic device having the same, and a method for determining a backlit condition, an exposure compensation method and an imaging method in the imaging apparatus. The imaging apparatus includes a body; an imaging unit installed in the body and configured to photograph an image in a first direction; an image processing unit configured to generate image data by processing the image; a light meter installed in the body and configured to measure light in a second direction corresponding to an incident direction of light different from an incident direction of light of the first direction; and a control unit configured to control first imaging unit to photograph the image at an exposure value calculated using a photometric value obtained by the light meter.

### CROSS-REFERENCE TO RELATED APPLICATION

This application claims priority to and the benefit under 35 U.S.C. §119(a) of Korean Patent Application Nos. 10-2012-0095890, filed on Aug. 30, 2012, and 10-2013-0020702, filed on Feb. 26, 2013, the entire disclosures of which are incorporated herein by reference for all purposes.

### BACKGROUND

1. Field

A following description relates to an imaging apparatus, and, more specifically, to an imaging apparatus providing exposure compensation and an electronic device having the same.

2. Discussion of the Background

Development in digital technology has prompted digital convergence. Recently, the most noticeable digital convergence occurs in the computer industry, the media and the communications. A typical product produced by digital convergence is a smart phone. In the smart phone, a variety of functional modules are combined, including an imaging apparatus. A portable electronic device, such as a smart phone and a tablet computer, has an imaging apparatus, or a camera, on both the front and the back (front surface and reverse surface) thereof.

Generally, an image captured by the imaging apparatus includes various kinds of information. Such information, of course, relates to an object which is placed in the image. The image is encoded into image data in a predetermined image processing. For the image processing, the imaging apparatus includes an image processing module, such as, a Digital Signal Processing (DSP). In addition, the encoded image data may be stored in a memory or may be decoded to thereby be displayed.

The image data includes luminance information and color information relating to the image. That is, even though the same object is photographed, different image data may be generated. In a common imaging apparatus, a lighting condition may be automatically set by detecting surrounding environment and/or may be set by a user. In the case where an object is in a special condition or where the user environment settings are set by a user to be unsuitable for a surrounding condition, the object may be displayed differently from what the user initially expected.

A case in point is backlight. If light is measured using a common light measurement method in a backlit condition and then an exposure value is set according to the light measurement, it may turn out that the object has very low luminance, compared to the is surrounding environment. In addition, it is hard for the user to determine an appropriate exposure value in a backlit condition. As a result, an object in the image may be hardly recognized, and such an image is called an “exposure lack image.”

In order to avoid the exposure lack image, it is necessary to perform proper pre-treatment and/or post-treatment on an image for backlight compensation. Backlight compensation in the pre-treatment indicates compensating an exposure value before photographing. Backlight compensation in the post-treatment is manipulating a photographed image to thereby generate a new image at a proper exposure value. If the pre-treatment is performed well, the post-treatment is not necessary. In addition, the pre-treatment and the post-treatment may be used to supplement each other.

There are many existing method for obtaining a proper exposure image in a backlit condition through pre-treatment. One exemplary method allows a user to select an area to measure light and set an exposure value based on the light measurement. Another method allows a user to compensate an exposure value to be greater than the light measurement of a corresponding imaging apparatus. However, such methods require a user's manipulation and fail to suggest specific ways of calculating an exposure value.

Another existing method utilizes an environment-object recognizing algorithm, which recognizes an environment of an object and compensates an exposure value based the recognition. In this method, a user is able to find out a proper exposure value by changing the values according to a result of the environment-object recognizing algorithm. However, it also requires a user's manipulation. In addition, it is necessary for the imaging apparatus to determine a backlit condition with high accuracy for backlight compensation.

Related art discloses an algorithm used for determining whether a lighting is condition is backlit. The algorithm detects an area having maximum luminance distribution based on luminance information of an image, so that it requires complicated processing to calculate the area having maximum luminance distribution. In addition, the above invention fails to suggest how to perform backlight compensation, in the case where the lighting condition is determined to be backlit.

### SUMMARY

Additional features of the invention will be set forth in the description that follows, and in part will be apparent from the description, or may be learned by practice of the invention.

According to exemplary embodiments, there is provided an imaging apparatus including: a body; an imaging unit installed in the body and configured to photograph an image of an object to be photographed in a first direction; an image processing unit configured to generate image data by processing the image; a light meter installed in the body and configured to measure light in a second direction corresponding to an incident direction of light different from an incident direction of light of the first direction; and a control unit configured to control the imaging unit to photograph the image at an exposure value calculated using a photometric value based on the light measured by the light meter.

According to exemplary embodiments, there is provided a method for determining a backlit condition, the method including: photographing an image of an object in a first direction with an imaging unit installed in a body; generating image data by processing the image; measuring light, with a light meter installed in the body, in a second direction corresponding to an incident direction of light different from an incident direction of light of the is first direction; and calculating an exposure value, with a processor, using a photometric value based on the light measured by the light meter, wherein the photographing by the image unit is based on the exposure value.

According to exemplary embodiments, there is provided an imaging apparatus including: a first imaging unit configured to capture a first image in a first direction; a second imaging unit configured to capture a second image in a second direction; and a control unit configured to control the first imaging unit to capture the first image at an exposure value calculated using a photometric value based on light incident to the first direction, wherein the incident light is measured in the second image, wherein the second image is captured prior to the first image.

It is to be understood that both the forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The above and other objects, features and advantages of the present disclosure will become apparent from the following description of certain exemplary embodiments given in conjunction with the accompanying drawings. The accompanying drawings, which are included to provide a further understanding of the invention and are incorporated in and constitute a part of this specification, illustrate embodiments of the invention, and together with the description serve to explain the principles of the invention.

FIG. 1 illustrates an imaging apparatus according to exemplary embodiments of is the present invention.

FIG. 2 illustrates an imaging apparatus according to exemplary embodiments of the present invention.

FIG. 3 illustrates an imaging apparatus according to exemplary embodiments of the present invention.

FIG. 4 illustrates a lighting condition where it is possible to photograph an image, according to exemplary embodiments of the present invention.

FIG. 5 is a flow chart illustrating an exposure compensation method according to exemplary embodiments of the present invention.

FIG. 6 is a flow chart illustrating a method for determining a backlit condition according to exemplary embodiments of the present invention.

FIG. 7 illustrates a process of calculating a first average luminance value of first areas and a second average luminance of second areas by dividing an image into a plurality of areas according to exemplary embodiments of the present invention.

FIG. 8 is a flow chart illustrating a method for determining a backlit condition according to exemplary embodiments of the present invention.

FIG. 9 is a flow chart illustrating an imaging method according to exemplary embodiments of the present invention.

FIG. 10 is a flow chart illustrating an imaging method according to exemplary embodiments of the present invention.

FIG. 11 is a flow chart illustrating an imaging method according to exemplary embodiments of the present invention.

Throughout the drawings and the detailed description, unless otherwise described, is the same drawing reference numerals will be understood to refer to the same elements, features, and structures. The relative size and depiction of these elements may be exaggerated for clarity, illustration, and convenience.

### DETAILED DESCRIPTION

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first,” “second,” and the like does not imply any particular order, but they are included to identify individual elements. Moreover, the use of the terms first, second, etc. does not denote is any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

In addition, embodiments described in the specification are wholly hardware, and may be partially software or wholly software. In the specification, “unit”, “module”, “device”, “system”, or the like represents a computer related entity such as hardware, combination of hardware and software, or software. For example, in the specification, the unit, the module, the device, the system, or the like may be an executed process, a processor, an object, an executable file, a thread of execution, a program, and/or a computer, but are not limited thereto. For example, both of an application which is being executed in the computer and a computer may correspond to the unit, the module, the device, the system, or the like in the specification.

Descriptions of well-known functions and constructions may be omitted for increased clarity and conciseness.

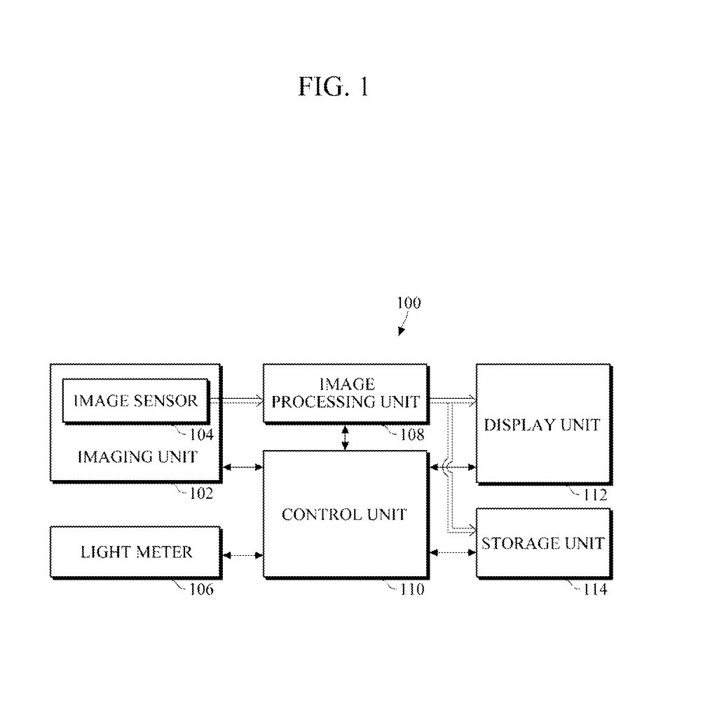

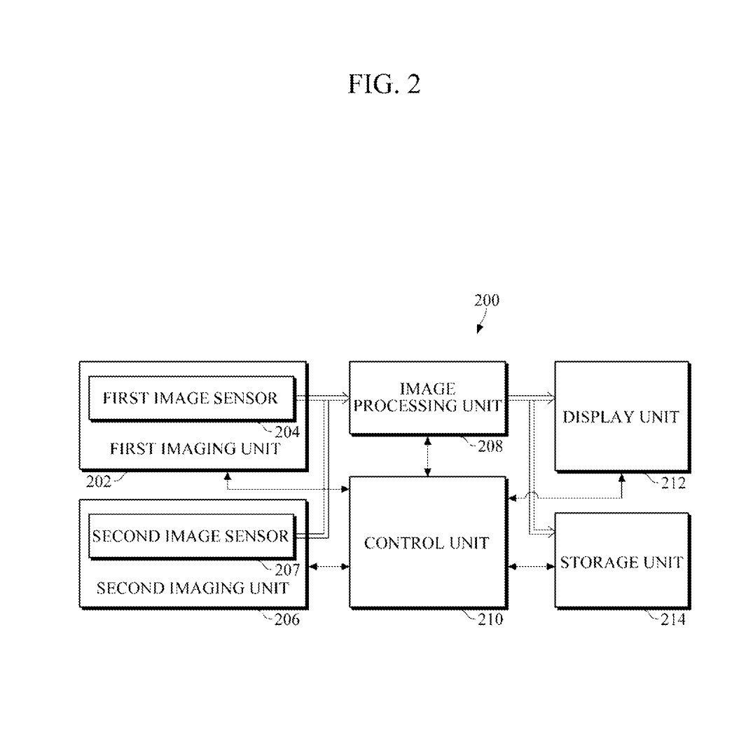

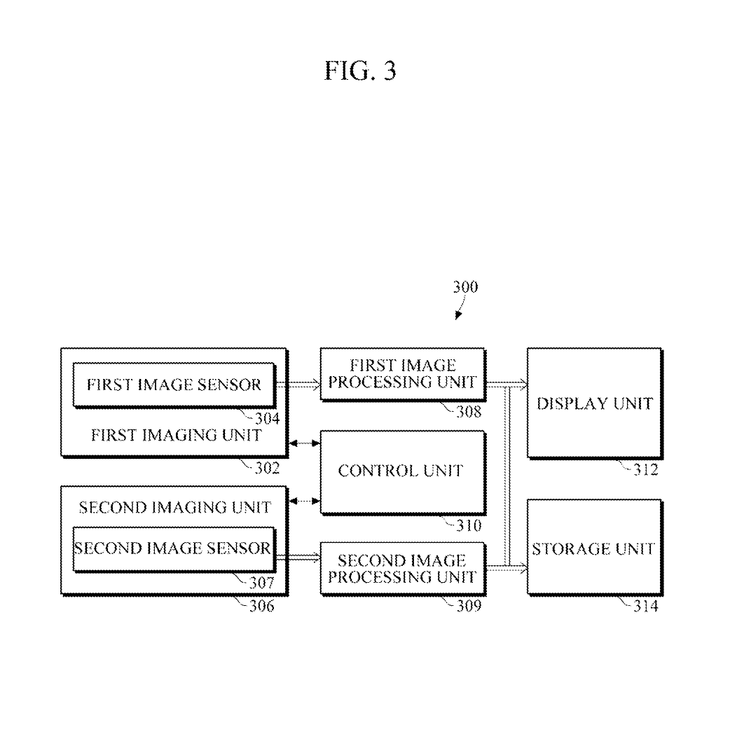

The imaging apparatuses 100, 200 and 300 illustrated in FIGS. 1 to 3 are exemplary, and the imaging apparatuses 100, 200 and 300 may include some of the modules illustrated in FIGS. 1 to 3 or other additional modules to operate the modules illustrated in FIGS. 1 to 3. FIG. 1 illustrates an imaging apparatus according to exemplary embodiments of the is present invention. Referring to FIG. 1, an imaging apparatus 100 includes an imaging unit 102 having an image sensor 104, an image processing unit 108, a control unit 110, a display unit 112 and a storage unit 114. In FIG. 1, each of one-directional arrows represents a flow of an image signal or data generated by the image signal, while each of bidirectional arrows represents a flow of an instruction or a control signal and/or other data (for example, a photometric value). One-directional and bidirectional arrows in FIGS. 2 and 3 indicate the same as those in FIG. 1.

An imaging apparatus 100 and other imaging apparatuses 200 and 300 in FIGS. 2 and 3 each may be an electronic device to record an image or a video, such as, a digital camera and a camcorder, but aspects of the present invention are not limited thereto. The imaging apparatuses 100, 200 and 300 may be an image pickup module in an electronic device which includes a smart phone and a tablet computer. Display units 112, 212 and 312 and storage units of 114, 214 and 314 in the imaging apparatuses 100, 200 and 300 may be a display module (for example, a front display of a smart phone) or a storage module (for example, memory in a smart phone).

An imaging unit 102 captures an image in which an object is placed. To this end, the imaging unit 102 includes an optical system including a lens, an iris used for adjusting an aperture of a lens, and a shutter which allows light to enter through the optical system. In addition, the imaging unit 102 further includes an image sensor 104 used for converting the light entered through the optical system into a digital signal. The image sensor 104 may vary. The image sensor 104 may include a Charge Coupled Device (CCD) image sensor, a Complementary Metal Oxide Semiconductor (CMOS) image sensor, and the like. The image sensor 104 may adjust International Standards Organization (ISO) sensitivity in response to a user manipulation and/or may automatically adjust ISO sensitivity according to a surrounding lighting condition.

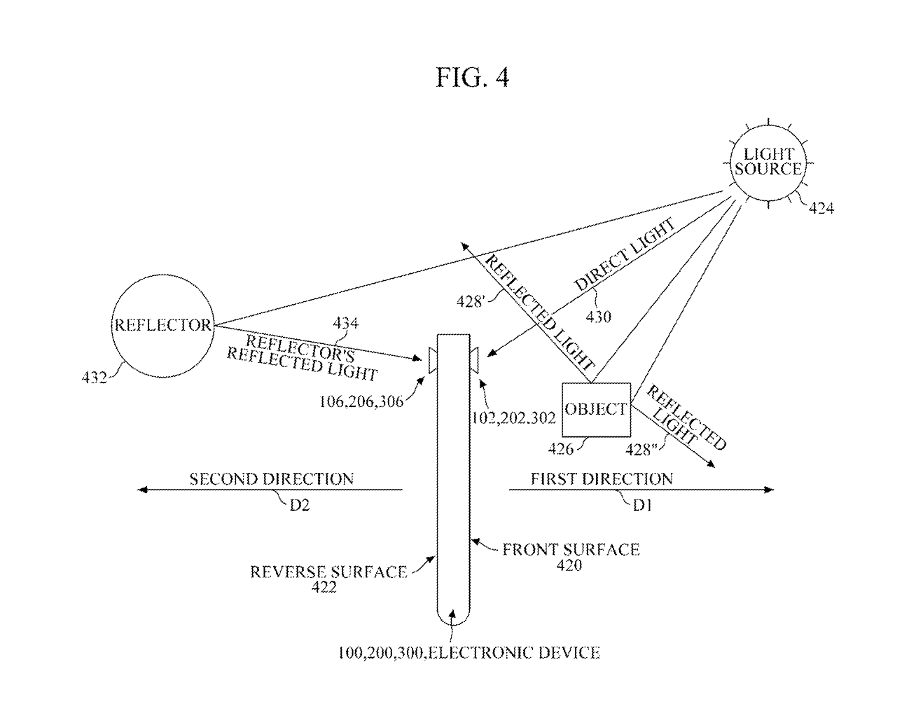

The imaging unit 102 may photograph an image in a predetermined direction with respect to the imaging apparatus 100. For example, the imaging unit 102 may photograph an image in a direction D1 extending away from a surface, for example, a front surface 420 of FIG. 4 of the imaging apparatus 100, where a lens is installed (see, FIG. 4). Accordingly, if a direction D1 which the front surface 420 of the imaging apparatus 100 faces is changed, a direction in which the imaging unit 102 photographs an image is changed as well. In some embodiments, the direction in which the image unit 102 photographs an image is changed with respect to the imaging apparatus 100. For instance, if positions and the direction of both an optical system and the image sensor 104 are changeable with respect to the imaging apparatus 100, the imaging unit 102 may not photograph an image in the same direction as the direction in which the front surface 420 of the imaging apparatus 100 faces.

A light meter 106 measures the amount of light, that is, luminance flux, which is incident in a predetermined direction. The direction in which the light meter 106 measures light may be fixed or changed. The light meter 106 may be an illumination sensor which measures the amount of light or brightness in a predetermined direction, but aspects of the present invention are not limited thereto. For example, as illustrated in FIGS. 2 and 3, the light meter 106 may calculate a photometric value based on luminance information of the image data generated from an image which is captured by image sensors 207 and 307 and/or imaging units 206 and 306, and, at this time, the image sensors 207 and 307 and the imaging units 206 and 306 are capable of measuring the illumination of light.

According to exemplary embodiments, the light meter 106 may measure the brightness or the amount of light in a direction corresponding to an incident direction of light, which is different from an incident direction of light of the direction in which the imaging unit 102 photographs an image. Here, “the direction different from a direction of incident light” indicates a direction which does not overlap a direction of incident light. For example, if the imaging unit 102 is installed toward the front surface 420 of the imaging apparatus 100, “the direction different from a direction of incident light” may indicate a direction toward the top, bottom, left, or right of reverse surface 422 of the imaging apparatus 100. Accordingly, light incidental on the imaging unit 102 does not fall directly on the light meter 106 whereas light incidental on the light meter 106 does not fall directly on the imaging unit 102.

In the case where the imaging unit 102 is in a backlit condition, if light measurement is performed by the imaging unit 102 or light measurement is performed with respect to a direction in which the imaging unit faces, and then an exposure value to be used in photography is calculated based on the resultant photometric value, an object may look dark due to direct incident light on the imaging unit 102, and thus, it may be difficult to recognize the object. This is a problem which a related art faces. However, if light measurement is performed with respect to a direction corresponding to an incident direction of light, different from an incident direction of light of a direction in which the imaging unit 102 faces, and then an exposure value of the imaging unit 102 is set based on the resultant photometric value, the drawback mentioned above may be prevented.

The light meter 106 may measure light in a direction opposite a direction in which the imaging unit 102 photographs an image. For example, if the imaging unit 102 photographs an image in a direction D1 extending from the front surface 420 (see FIG. 4) of the imaging apparatus 100, the light meter 106 may measure light in a direction D2 extending from the reverse surface 422 of the imaging apparatus 100. Accordingly, light reflected by another object located behind the imaging apparatus 100 is measured to thereby calculate an exposure value of is the imaging unit 102 (See FIG. 4). Generally, reflected light properly represents brightness (luminance) of the surroundings of the imaging apparatus 100. Thus, in the case where an exposure value of the imaging unit 102 is set using a photometric value calculated by the light meter 106 which measures light in a direction opposite to a direction which the imaging unit 102 faces, it is possible to obtain an image optimized in a surrounding lighting condition at that time and to recognize an object in the image.

In order to generate image data, an image processing unit 108 processes an image captured by the imaging unit 102. That is, the image processing unit 108 processes a digital signal of an image generated by the image sensor. The image processing unit 108 may generate any kind of image data in any format. For example, image data may include luminance information and color information of each pixel composing an image. In another example, the image data may include RGB information of each pixel composing the image. The luminance information or information about brightness of each pixel composing a corresponding image may be utilized when a control unit 110 determines whether the imaging unit 102 is in a backlit state.

The control unit 110 provides management, processing and control required to operate the imaging apparatus 100. For example, the control unit 110 may control an operation, such as, focus calculation, face recognition and other functions installed in an automatic digital camera, for the imaging unit 102 to photograph an image or may perform operation control and/or signal processing required for the light meter 106 to measure light. The control unit 106 may perform an operation control or signal processing for executing a predetermined functional module or program installed in the imaging apparatus 100. The control unit 110 may perform predetermined signal processing on a visual, audio and machinery input signal which is received from an input module (not illustrated) or a sensor module of the imaging apparatus 100, and then is control an output module. For example, a display unit 112 can output a result of the signal processing as a preview, a full photographed image a result of operations executed by the control unit 110, and the like as a visual signal.

The control unit 110 may control the imaging unit 102 to photograph an image at an exposure value calculated using the photometric value that is calculated by the light meter 106. When the imaging unit 102 is in a backlit condition, the control unit 110 may control the imaging unit 102 to photograph an image using the photometric value calculated by the light meter 106. To this end, the control unit 110 may transmit a driving signal to the light meter 106 to measure light and, in response, receive a photometric value from the light meter 106. According to exemplary embodiments of the present invention, the control unit 110 may drive the light meter 106 only when the imaging unit 102 is in a backlit condition. In some embodiments, the control unit 110 may drive the light meter 106 to determine whether a lighting condition is backlit.

In some embodiments, calculation of an exposure value based on the photometric value calculated by the light meter 106 may be performed by the control unit 110. The exposure value can be used by the imaging unit 102 to photograph an image. The light meter 106 can measure light in a direction different from a direction of light incidental on the imaging unit 102 and then the imaging unit 102 can calculate an exposure value based on the photometric value calculated by the light meter 106. In some embodiments, other elements of the imaging apparatus 100 can play a role in calculating the exposure value. For example, the imaging unit 102 may calculate an exposure value based on the photometric value received from the control unit 110. The photometric value may be transmitted from the light meter 106 to the imaging unit 102 through the control unit 110, directly to the imaging unit 102 without going through the is control unit 110, and the like.

The control unit 110 may determine whether the imaging unit 102 is in a backlit condition by using image data of an image captured by the imaging unit 102 or by using both a photometric value calculated with respect to a direction in which the imaging unit 102 photographs an image and a photometric value calculated by the light meter 106. A process used in the above backlight determination is described in detail below. The imaging apparatus 100 may include an additional light meter, for example, an illumination sensor (not illustrated), utilize image data generated from an image captured by the imaging unit 102 and/or make use of the image sensor 104 included in the imaging unit 102, so as to calculate a photometric value with respect to a direction in which the imaging unit 102 photographs an image.

The display unit 112 displays the image captured by the imaging unit 102. The display unit 112 may display the image data generated by the image processing unit 108 or display the image captured by the imaging unit, for example, a ‘preview’ of a photographed image. Such an operation of the display unit 112 may be controlled by the control unit 110. For example, in the case when the imaging unit 102 is in a backlit condition, the control unit 110 may control the display unit 112 to display as a preview image an image that is captured by the imaging unit 102 at an exposure value calculated based on the photometric value calculated by the light meter 106.

The storage unit 114 can temporarily and/or constantly store the image data generated by the image processing unit 108. The storage unit 114 may store user environment settings relating to a backlit condition. According to the user environment settings stored in the storage unit 114, the control unit 110 may or may not determine whether a lighting condition is backlit. The user environment settings may be set by a user before photographing or may be is auto set. According to the user environment settings, the control unit 110 may control the imaging unit to photograph an image in a backlit condition at an exposure value calculated based on the photometric value calculated by the light meter 106, or the control unit 110 may photograph an image in a backlit condition in response to a user input signal.

FIG. 2 illustrates an imaging apparatus according to exemplary embodiments of the present invention. An imaging apparatus 200 includes a first imaging unit 202, a first image sensor 204, a second imaging unit 206, a second image sensor 207, an image processing unit 208, a control unit 210, a display unit 212 and a storage unit 214. The imaging apparatus 200 of FIG. 2 is different from the imaging apparatus 100 of FIG. 1, as the imaging apparatus 200 includes two imaging units 202 and 206 whereas the imaging apparatus 100 includes one imaging unit 102 and one light meter 106. Therefore, although elements of the imaging apparatus 200 are not described in the following description, the same elements may be utilized in the imaging apparatus 100.

Each of the first imaging unit 202 and the second imaging unit 206 captures an image having an object. That is, the first imaging unit 202 and the second imaging unit 206 may perform the same function as that of the imaging unit 102 in FIG. 1. Each of the first imaging unit 202 and the second imaging unit 206 may photograph an image in a direction with respect to the imaging apparatus 200. A direction in which the first imaging unit 202 photographs an image corresponds to an incident direction of light different from that of a direction in which the second imaging unit 206 photographs an image. The direction in which the first imaging unit 202 photographs an image may be opposite the direction that the second imaging unit 206 photographs an image. For example, the first imaging unit 202 may be arranged in the front surface of the imaging apparatus 200, whereas the second imaging unit 206 is arranged in the is reverse surface 422 of the imaging apparatus 200.

If the first imaging unit 202 or the second imaging unit 206 photographs an image, the other imaging unit may perform the same function as that of the light meter 106 shown in FIG. 1, and vice versa. For example, at a time when the first imaging unit 202 photographs an image, the second imaging unit 206 may calculate a photometric value, and vice versa. To this end, the first imaging unit 202 or the second imaging unit 206 may further include a photometric module for light measurement, for example, an illumination sensor. For example, the photometric module may be a functional module which is commonly embedded in a general imaging unit, but aspects of the present invention is not limited thereto. An operation of the photometric module can include calculating a photometric value using the first image sensor 204, the second image sensor 207, image data generated by the image processing unit 208 from an image captured by the first imaging unit 202, or image data generated by the image processing unit 208 from an image captured by the second imaging unit 206.

The imaging apparatus 200 may include an additional light meter, for example, an illumination sensor, regardless of the capability of the first and second imaging units 202 and 206 to measure light. The imaging apparatus 200 may include an additional photometric module, in addition to the two imaging units 202 and 206, for example, an illumination sensor (not illustrated) to calculate a photometric value. Functions and operations of the photometric module may be the same as those of the light meter 106 in FIG. 1, so relevant detailed description is not provided herein. The imaging apparatus 200 may include one photometric module, not necessarily two or more photometric modules corresponding to the various imaging units.

It can be difficult for the two imaging units 202 and 206 to photograph an image and/or measure light simultaneously as the imaging apparatus 200 includes one image processing unit 208. Thus, the control unit 210 may control the two imaging units 202 and 206 to operate at a different time. The duration between operation of the two imaging units 202 and 206 may be less than a minute, for example, less than 30 seconds, less than 10 seconds, less than 2 seconds, less than 1 second, less than 20 milliseconds, or the like. For example, in the case of using the first imaging unit 202 to photograph an image, the control unit 210 may control the second imaging unit 206 to measure light so as to determine whether the first imaging unit 202 is in a backlit condition and/or to determine an exposure value of the first imaging unit 202. In the case, the control unit 210 may momentarily suspend operation of the first imaging unit 202 and then control the second imaging unit 206 to operate. The momentary suspension can be a short duration, for example, short-enough for a user not to notice the suspension.

FIG. 3 illustrates an imaging apparatus according to exemplary embodiments of the present invention. An imaging apparatus 300 includes a first imaging unit 302, a first image sensor 304, a second imaging unit, a second image sensor 307, a first image processing unit 308, a second image processing unit 309, and a control unit 310, a display unit 312 and a storage unit 314. Similar to the imaging apparatus 200 in FIG. 2, the imaging apparatus 300 in FIG. 3 is different from the imaging apparatus 100 in FIG. 1, as the imaging apparatus 300 includes the two imaging units 302 and 306 whereas the imaging apparatus 100 includes one imaging unit 102 and one light meter 106. The imaging apparatus 300 is different from the imaging apparatus 200, as well, in that the imaging apparatus 300 includes the two image processing units 308 and 309, which respectively correspond to the two imaging units 302 and 306. Hereinafter, the distinctive difference of the imaging apparatus 300 in FIG. 3, compared to the imaging apparatus 200 in FIG. 2, will be mainly described. Therefore, although elements of the imaging apparatus 300 are not described in the following description, the same elements associated with imagining apparatuses 100 and 200 may be utilized in the imaging apparatus 300.

The imaging apparatus 300 includes the two image processing unit 308 and 309 that respectively correspond to the two imaging units 302 and 306. In more detail, the first imaging unit 302 is connected with the first image processing unit 308, whereas the second imaging unit 306 is connected with the second image processing unit 309. Therefore, the first image processing unit 308 is able to generate image data by processing an image captured by the first imaging unit 302, whereas the second image processing unit 309 is able to generate image data by processing an image captured by the second imaging unit 306. Accordingly, it is possible to photograph an image and/or measure light by operating the two imaging units 302 and 306 simultaneously or at the same time. For example, the first imaging unit 302 may photograph an image, and, at the same time, the second imaging unit 306 may measure light.

To this end, the control unit 310 may control the two imaging units 302 and 306 to operate simultaneously or separately at a different time. For example, in the case of using the first imaging unit 302 to photograph an image, the control unit 310 may control the second imaging unit 306 simultaneously or sequentially so as to determine the first imaging unit 302 is in a backlit condition or to determine an exposure value of the first imaging unit 302, if necessary.

FIG. 4 illustrates a lighting condition where it is possible to photograph an image, according to exemplary embodiments of the present invention. In FIG. 4, the imaging unit 102 and the first imaging units 202 and 302 (hereinafter, collectively referred to as ‘first-sided imaging units 102, 202 and 302’) and the light meter 106 and the second imaging units 206 and 306 (hereinafter, collectively referred to as ‘second-sided light meters 106, 206 and 306’) are arranged in the imaging apparatuses 100, 200 and 300, illustrated in FIGS. 1 to 3, or an electronic device having the same. With reference to exemplary FIG. 4, the first-side imaging units 102, 202 and 302 are arranged on a front surface 420 to face a direction D1 opposite a reverse surface 422 direction D2 in which the second-sided light meters 106, 206 and 306 are arranged. The arrangement between the imaging unit 102 and the light meter 106, between the imaging unit 202 and the second imaging unit 206, and between the imaging unit 302 and the second imaging unit 306 may be different from what is illustrated in FIG. 4, so long as an incident direction of light of one element does not correspond to that of the other. The electronic device 100, 200, 300 of FIG. 4 may be an electronic device, for example, a smart phone, a tablet computer, a laptop, and the like, that includes both a front-facing camera and a reverse-facing camera, but aspects of the present invention are not limited thereto.

As illustrated in FIG. 4, the first-sided imaging units 102, 202 and 302 of the imaging apparatuses 100, 200 and 300, respectively, or the electronic device having the same, are in a backlit condition. The backlit condition refers to a case where there is a light source 424 behind an object 426 to be photographed by the first-sided imaging units 102, 202 and 302. In the backlit condition, reflected light 428′, 428″ from the object 426 may not be incidental on the first-sided imaging units 102, 202 and 302, whereas direct light 430 from the light source 424 is incidental on the first-sided imaging units 102, 202 and 302. In the backlit condition, direct light from light source 424 may not be incidental on the second-sided light meters 106, 206 and 306, whereas reflected light 434 from a reflector 432 is incidental on the second-sided light meters 106, 206 and 306. Reflector 432 is disposed facing the reverse surface 422 of the imaging apparatuses 100, 200 and 300. In other words, the light source 424 and the reflector 432 are disposed around the electronic device 100, 200, 300, with each facing opposing surfaces.

The first-sided imaging units 102, 202 and 302 may photograph an image at an exposure value calculated using a photometric value (for example, illumination) calculated by the second-sided light meters 106, 206 and 306. When the first-sided imaging units 102, 202 and 302 are in a backlit condition, the control units 108, 208 and 308 in the imaging apparatuses 100, 200 and 300 may control the first-sided units 102, 202 and 302 so as to photograph an image using the photometric value calculated by the second-sided light meters 106, 206 and 306. The second-sided light meters 106, 206 and 306 meter reflected light 434 of a reflector 432 and the reflected light corresponds to front or photographing light of object 426, so that the first-sided imaging units 102, 202 and 302 of the imaging apparatuses 100, 200 and 300 are able to photograph an image at an exposure value suitable for a surrounding lighting condition (for example, brightness according to a type and a location of a light source).

An exposure value refers to an amount of light that each of the imaging apparatuses 100, 200 and 300 receives and detects. Generally, an exposure value may be adjusted by adjusting an aperture, a shutter speed and an IOS sensitivity of an image sensor.

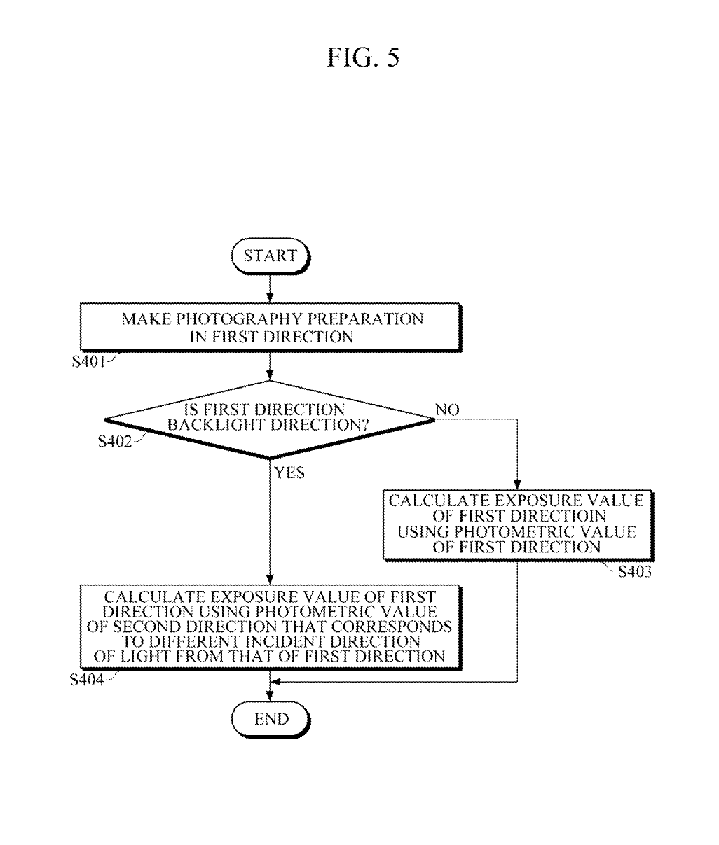

FIG. 5 is a flow chart illustrating an exposure compensation method according to exemplary embodiments of the present invention. The exposure compensation method may be used for photographing an image using the imaging apparatuses 100, 200 and 300 illustrated in FIGS. 1 to 3, or an electronic device having the same. Therefore, the following description will be mainly about the exposure compensation method, and any elements and operations omitted in the following description may be the same as those which are explained with reference to FIGS. 1 to 4.

Referring to FIGS. 1 to 5, preparation is made with respect to a first direction in which an image apparatus is to photograph an image in operation S401. Herein, ‘the first is direction in which the imaging apparatus is to photograph an image’ or photographed direction refers to a direction which the first-sided imaging units 102, 202 and 302 of the imaging apparatuses 100, 200 and 300, or an electronic device having the same, face. That is, the photographed direction indicates a direction in which the object to be photographed is located. In addition, ‘preparation’ may include a predetermined activity required for a user to photograph an image in the first direction. For example, preparation may include obtaining a preview image by directing the first-sided imaging units 102, 202 and 302 toward the first direction.

In S402, it is determined whether the first direction in which an image is to be photographed or photographed direction is a direction in a backlit condition. Here, the case where ‘the first direction is a backlight-direction’ indicates a case where the imaging apparatuses 100, 200 and 300, or an electronic apparatus having the same, are arranged in a backlit condition, for example, when a light source is behind an object to be photographed. When the light source 424 is located in a direction where the first-sided imaging units 102, 202 and 302 of the imaging apparatuses 100, 200 and 300 are as illustrated in FIG. 4, the first-sided imaging units 102, 202 and 302 are in a backlit condition. The control units 110, 210 and 310 of the imaging apparatuses 100, 200 and 300 may determine whether the imaging units 102, 202 and 302 are in a backlit condition as described above.

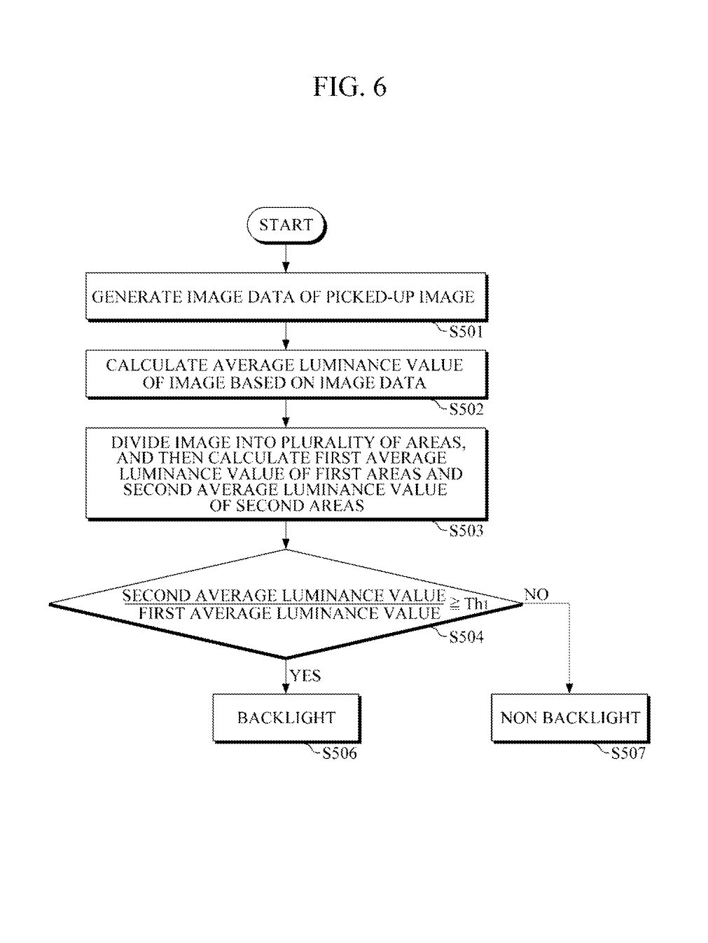

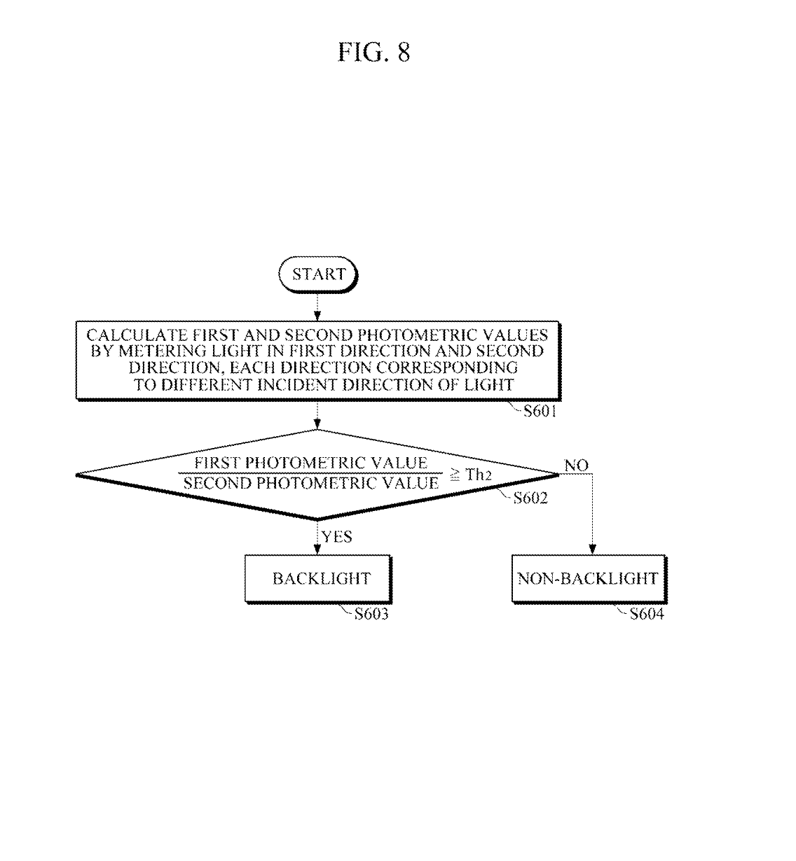

According to exemplary embodiments of the present invention, the control units 110, 210 and 310 may determine whether the first-sided imaging units 102, 202 and 302 are in a backlit condition using existing algorithms. For example, the control units 110, 210 and 310 may carry out the determination using a known process. However, the present invention is not limited thereto, so the control units 110, 210 and 310 may determine whether a lighting condition is backlit, using a method for determining a backlit condition illustrated either in FIG. 6 or in FIG. 8.

FIG. 6 is a flow chart illustrating a method for determining a backlit condition according to exemplary embodiments of the present invention. The method for determining a backlit condition shown in FIG. 6 utilizes image data generated from an image captured by an imaging unit which takes a photograph. That is, it is a case of using image data captured by the first-sided imaging units 102, 202 and 302 in the embodiment in FIG. 4.

Referring to FIG. 6, image data is generated using an image captured by the first-sided imaging units 102, 202 and 302 in S501. As described above with reference to FIGS. 1 to 3, the image processing units 108, 208 and 308 may generate image data per pixel on a predetermined format from an image captured by the first-sided imaging units 102, 202 and 302, respectively.

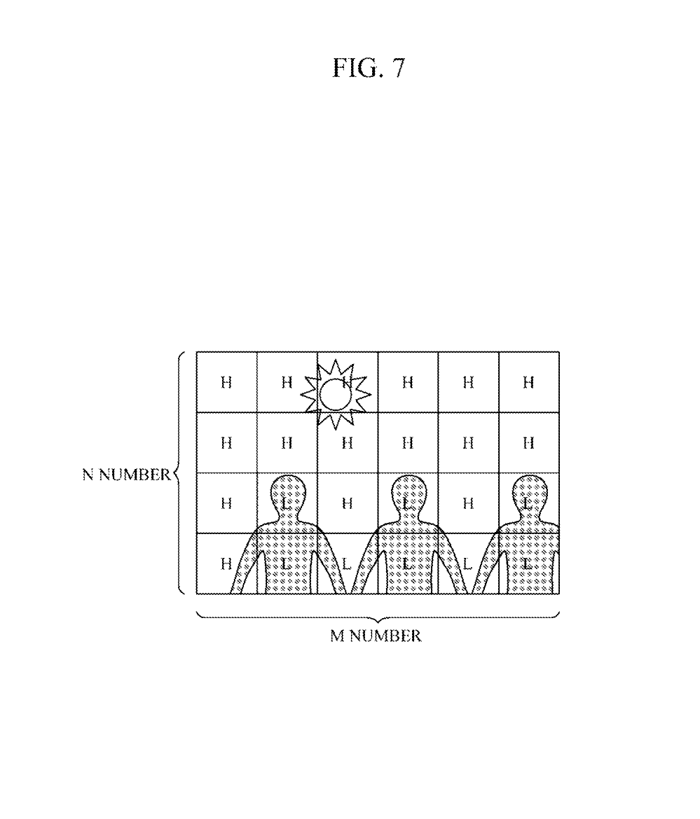

In operation S502, an average luminance value of the image is calculated using the image data generated. The average luminance value is calculated either by dividing a sum of luminance values of all pixels by the number of pixels; or by dividing the image into predetermined-sized blocks, calculating an average luminance value on a block basis, calculating a sum of average luminance values of all blocks, and then dividing the sum by the number of blocks. In operation S503, the second method may be more effective, but aspects of the present invention are not limited thereto. With regard to the second method, a block size is not limited specifically, so a block may be a macro block (16×16 pixel) or a block whose size is bigger than, a half of, or a quarter of that of the macro block. In some embodiments, an exemplary block illustrated in FIG. 7 may be utilized.

Next, by dividing the image into a plurality of areas, a first average luminance value and a second average luminance value are calculated with respect to a first area and the is second area. Here, the ‘first area’ refers to an area having an average luminance value smaller than the average luminance value of the image which is calculated in the above operation S502, whereas the ‘second area’ indicates an area having an average luminance value greater than the average luminance value of the image which is calculated in the above operation S502. Accordingly, the first average luminance value is calculated by adding average luminance values of all first areas and then dividing the sum of the average luminance values by the number of the first areas, whereas the second average luminance value is calculated by adding average luminance values of all second areas and then dividing the sum by the number of the second areas. If the image is divided into predetermined-sized blocks to thereby calculate an average luminance value on a block basis, an area in the operation S503 may not correspond to a block in the above operation S502, but aspects of the present invention are not limited thereto.

FIG. 7 illustrates a process of calculating a first average luminance value of first areas and a second average luminance of second areas by dividing an image into a plurality of areas according to exemplary embodiments of the present invention. Referring to FIG. 7, a symbol in the shape of sun indicates a light source, whereas a figure in the shape of human is an object.

FIG. 7 shows a case where an image is divided into M (X-axis)×N (Y-axis) blocks. Even though the image is divided into twenty (5×4) blocks (areas) in FIG. 7, it is merely an example. An image may be divided into greater or less than twenty blocks (areas). For example, each of M and N may be an integral greater than ten (10), but, logically, M and N can be as low as two (2).

In FIG. 7, a block is marked with an H or L. An L is a first area having an average luminance value less than an average luminance value of a corresponding image, is whereas a block (or an area) indicated by H is a second area having an average luminance value greater than the average luminance value of the corresponding image. Therefore, a first average luminance value is an average of luminance values of the first blocks indicated by L, whereas a second average luminance value is an average of luminance values of the second blocks indicated by H.

Referring to FIG. 6, whether a ratio of the second average luminance value to the first average luminance value is greater than a threshold (Th1) is determined in operation S504. As described in operation S504, whether a lighting condition is backlit is determined according to an equation using a ratio of the second average luminance value to the first average luminance value. The equation used in operation S504 is merely an example of calculating a ratio between the first average luminance value and the second average luminance value. In addition, the above-mentioned equation may be replaced with another equation. For example, the equation may use a ratio of the first average luminance value to the second average luminance value, or a function which has the first average luminance value and the second average luminance value as variables.

In addition, the threshold Th1 in operation S504 is not specifically limited. That is, the threshold Th1 may be randomly determined by collecting data of various image samples of a backlit condition. For example, a threshold Th1 may have an exemplary value of 2. Since the ratio of the second average luminance value to the first average luminance value indicates that a relative difference in brightness between dark areas and bright areas is above a predetermined level, the equation used in operation S504 may be efficient in determining whether a lighting condition is backlit. If the ratio of the second average luminance value to the first average luminance value is greater than a predetermined threshold Th1 according to the is result of operation S504, it is determined that a lighting condition is backlit in operation S506. If the ratio of the second average luminance value to the first average luminance value is less than a predetermined threshold Th1 according to the result of operation S504 is that, it is determined that a lighting condition is not backlit, that is, non-backlight in operation S507.

FIG. 8 is a flow chart illustrating a method for determining a backlit condition according to exemplary embodiments of the present invention. The method for determining a backlit condition in FIG. 8 relates to determining whether a lighting condition is backlit by measuring light in two or more directions, each of the directions corresponding to a different incident direction of light. Here, the directions may be a first direction in which an object is located, and a second direction corresponding to an incident direction of light different from that of the first direction. The second direction may be opposite to the first direction.

Referring to FIG. 8, in operation S601 a first photometric value and a second photometric value is calculated by measuring light in the first direction and the second direction, each direction corresponding to a different incident direction of light. The first and second photometric values may be measured, calculated or determined using an illumination sensor, an image sensor included, for example, in a light meter, and/or using image data of an image captured by a light meter. In some embodiments, the first photometric and the second photometric values may be calculated simultaneously. In some embodiments, the first photometric and the second photometric values may be calculated sequentially. For example, the imaging apparatus 200 in FIG. 2 may calculate the first photometric value using image data of an image captured by the first imaging unit 202, and then calculate the second photometric value using image data of an image captured by the second imaging unit 206.

In operation S602, it is determined whether a ratio of the second photometric is value to the first photometric value is above a predetermined threshold Th2. According to exemplary embodiments of the present invention, whether a lighting condition is backlit is determined according to a predetermined equation using a ratio between the first photometric value and the second photometric value, similar to operation S602. The equation used in operation S602 is merely an example of calculating a ratio between the first photometric value and the second photometric value, and the equation may be replaced with another equation for calculating a ratio between the first photometric value and the second photometric value. For example, the equation may be an equation for calculating a ratio of the first photometric value to the second photometric value or a predetermined function having the first and second photometric values as variables.

In addition, the threshold Th2 with respect to operation S602 is not specifically limited, similar to the threshold Th1 which is mentioned above in operation S504 with reference to FIG. 6. For example, the threshold value Th2 may be determined using database which is constructed with respect to various backlit conditions by measuring light both in a direction toward a light source and in the opposite direction, and then collecting respective photometric values. For example, the threshold Th2 may have an exemplary value of 2. Since the ‘ratio of the second photometric value to the first photometric value being greater than a predetermined threshold Th2’ indicates that a brightness difference between brightness coming from a direction in which a light source is located (that is, brightness of incident light coming from the light source) and brightness coming from the opposite direction (that is, brightness of reflected light of a reflector) is above a predetermined level, the equation used in operation S602 may determine whether a lighting condition is backlit. If the ratio of the second photometric value to the first photometric value is greater than the predetermined threshold Th2 according to the result of is operation S602, it is determined that a lighting condition is backlit in operation S603. If the ratio of the second photometric value to the first photometric value is less than the predetermined threshold Th2 according to the result of operation S602, it is determined that a lighting condition is not backlit, that is, non-backlight in S604.

Referring to FIG. 5, if it is determined that the first direction is a backlight direction according to the result of operation S402, an exposure value is calculated in the second direction which corresponds to an incident direction of light different from that of the first direction in operation S403. For example, the second direction may be opposite the first direction, as described above. In addition, the light meter 106, the imaging unit 206, and the imaging unit 306 of the imaging apparatuses 100, 200 and 300, respectively, may measure light in the second direction, as described above. If it is determined that the first direction is not a backlight direction according to the result of operation S402, an exposure value is calculated using an existing method in operation S404. For example, an exposure value with respect to the first direction may be calculated using a photometric value which is calculated with respect to the first direction.

As such, the method for determining a backlit condition measures light in a direction corresponding to a different incident direction of light from as direction toward which a photograph is to be taken, (for example, an opposite direction) and to set an exposure value of an imaging unit using a resultant photometric value. In most cases, a photometric value with respect to a direction in which a light source is located is greater than any photometric value with respect to other directions. In addition, in the opposite direction against the direction in which the light source is located, brightness of light reflected from a reflector is measured, and thus, a photometric value with respect to the opposite direction is appropriate to represent the is surrounding environment of an object. Therefore, if a photograph is taken at an exposure value using the exposure compensation method presented in the embodiments of the present invention, an object may be displayed in an image more clearly and more realistically.

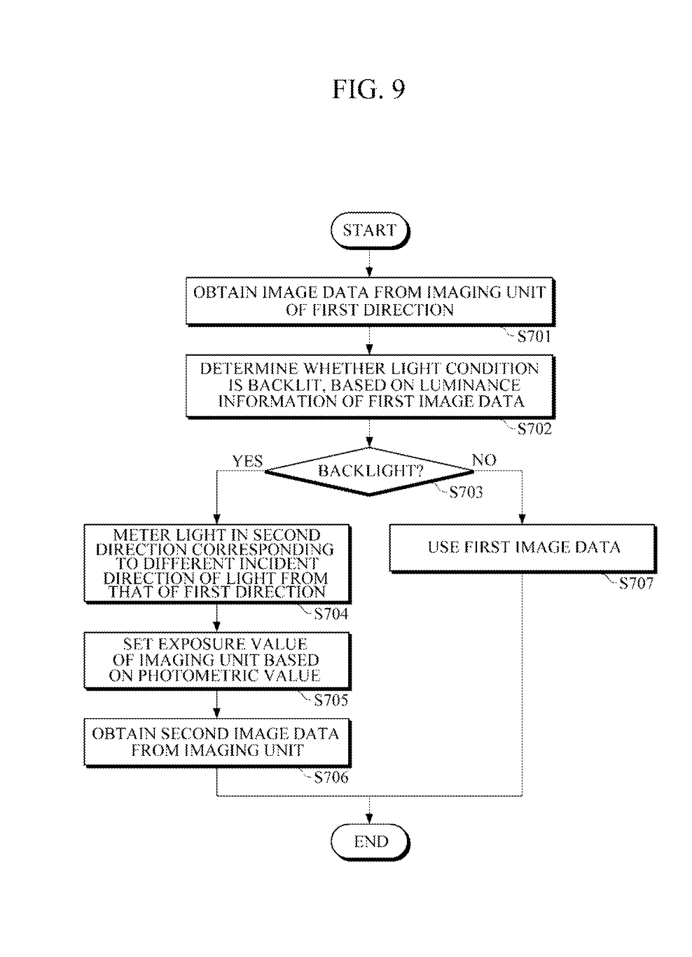

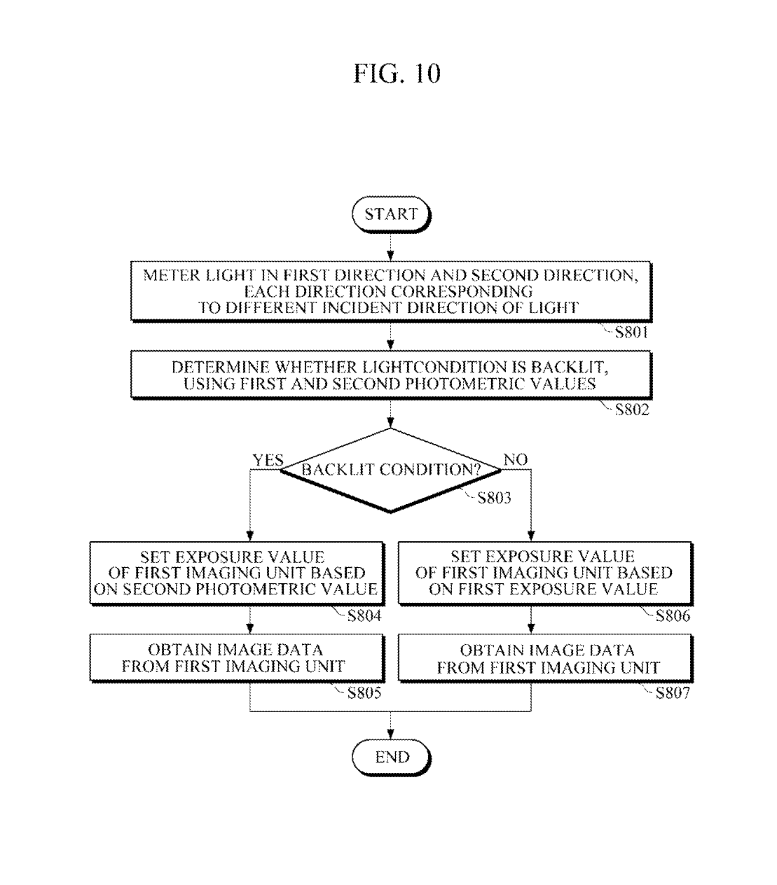

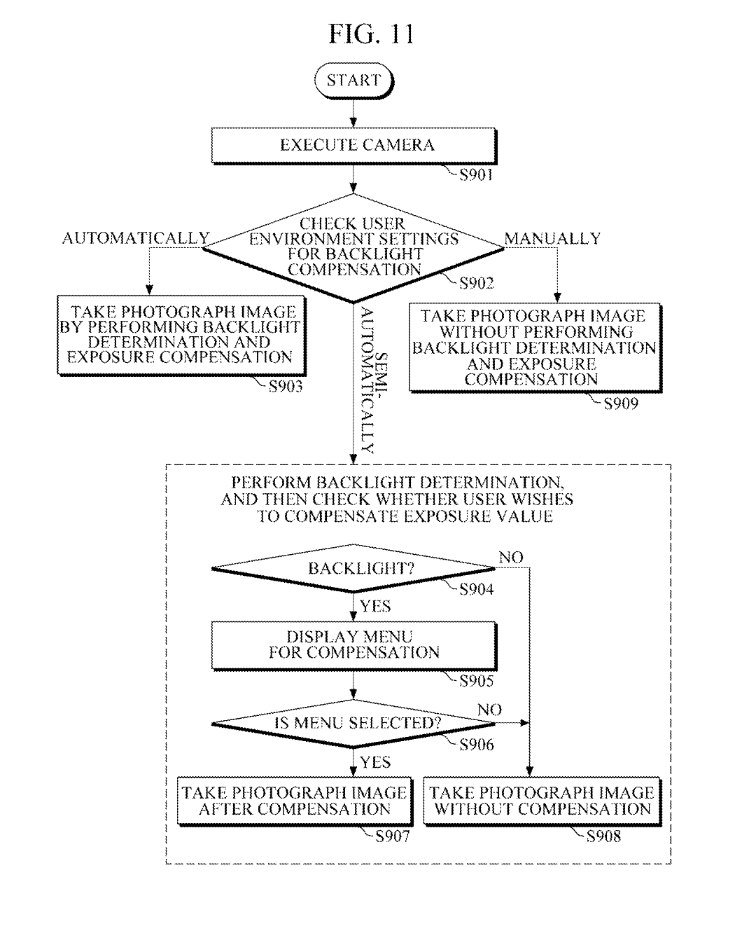

Hereinafter, an imaging method will be provided with reference to FIGS. 9 to 11 according to exemplary embodiments of the present invention. The imaging method described with reference to FIGS. 9 to 11 is performed in the imaging apparatuses illustrated in FIGS. 1 to 3, or an electronic device having the same, and such an imaging method may utilize a method for determining a backlit condition illustrated in FIG. 6 or FIG. 8. FIG. 9 is a flow chart illustrating an imaging method according to exemplary embodiments of the present invention. FIG. 9 may relate to an imaging method utilizing the method for determining a backlit condition described with reference to FIG. 6. FIG. 10 is a flow chart illustrating an imaging method according to exemplary embodiments of the present invention. FIG. 10 may relate to an imaging method utilizing the method for determining a backlit condition described with reference to FIG. 8. FIG. 11 is a flow chart illustrating an imaging method according to exemplary embodiments of the present invention. FIG. 11 may adaptively apply the exposure compensation method according to user environment settings. Hereinafter, the imaging methods are briefly described with reference to drawings according to exemplary embodiments of the present invention, but such descriptions are merely for the sake of explanation. Thus, any elements and operations omitted in the following description may be the same as those mentioned with reference to FIGS. 1 to 8.

FIG. 9 is a flow chart illustrating an imaging method according to exemplary embodiments of the present invention. As described above, the imaging method illustrated in FIG. 9 is an imaging method utilizing the method for determining a backlit condition described with reference to FIG. 6, and such a method may be performed by the imaging apparatuses 100, 200 and 300 in FIGS. 1 to 3, or an electronic device having the same.

Referring to FIGS. 1 to 3 and FIG. 9, in operation S701, first image data is acquired from the imaging units 102, 202 and 302, each located in the first direction. The first image data may be generated from the processing performed by the image processing units 108, 208 and 308 of an image captured by the imaging units 102, 202 and 302, each imaging unit located in the first direction.

In operation S702, it is determined whether a lighting condition is backlit using luminance information of the first image data. Operation S702 determines whether each of the imaging units 102, 202 and 302 is in a backlit condition. In operation S702, it is determined whether a lighting condition is backlit using the method described with reference to FIG. 6, but aspects of the present invention are not limited thereto. The result of operation S702 determines a following operation of operation S703.

If it is determined that each of the imaging units 102, 202 and 302 is not (the “NO” branch) in a backlit condition according to the result of operation S703, the exposure compensation method according to the exemplary embodiments of the present invention is not utilized, and instead, the first image data acquired in operation S701 becomes image data of a photographed image in operation S707. If it is determined that each of the imaging units 102, 202 and 302 is in a backlit condition (the “YES” branch), the exposure compensation method according to the exemplary embodiments of the present invention is utilized.

In operation S704, when it is determined that each of the imaging units 102, 202 and 303 is in a backlit condition, light measurement in the second direction corresponding to an incident direction of light different from that of the first direction is performed. The light measurement in operation S704 may be performed by the light meter 106, the second imaging is unit 202, or the second imaging unit 302. In exemplary embodiments of the present invention, light measurement in operation S704 follows operation S701 or S702, but it is merely an example. The light meter 106, the second imaging unit 206, or the second imaging unit 306 may measure light concurrently during the time when the imaging units 102, 202 and 302 capture an image in operation S701. If it is determined that a lighting condition is backlit according to the result of operation S703, operation S705 may be performed without performing operation S704.

In operation 705, an exposure value to be used in the imaging units 102, 202 and 302 are calculated using the photometric value calculated in operation S704, and the calculated exposure value is set to be an exposure value of the imaging units 102, 202 and 302. As described above, operation S705 may be performed by the control units 110, 210 and 310 or by the imaging units 102, 202 and 302. Here, each of the control units 110, 210 and 310, or each of the imaging units 102, 202 and 302 may determine that the exposure value calculated in operation S705 is an exposure value of the imaging units 102, 202 and 302. However, aspects of the present invention are not limited thereto, so an exposure value may be determined by reflecting a photometric value, which is obtained by the imaging units 102, 202 and 302 with respect to the first direction.

In operation S706, an image is captured by the imaging units 102, 202 and 302 at the exposure value set in operation S705, and then the image processing units 108, 208 and 308 generates second image data by processing the image. There is no specific limitation on how to apply an exposure value, when an image is captured by the imaging units 102, 202 and 302 using a set exposure value. For example, an exposure value may be applied by adjusting a size of an aperture, a shutter speed, ISO sensitivity, or a combination thereof.

FIG. 10 is a flow chart illustrating an imaging method according to exemplary is embodiments of the present invention. As described above, the imaging method illustrated in FIG. 10 utilizes a method for determining a backlit condition described with reference to FIG. 8, and such an imaging method may be performed by the imaging units 100, 200 and 300 in FIGS. 1 to 3, or an electronic device having the same.

Referring to FIGS. 1 to 3 and FIG. 10, light measurement both in a first direction and in the second direction, each direction corresponding to a different incident direction of light, is performed in operation S801. Light measurement can be performed on images captured in the first direction and in the second direction; these captured images can be used to calculate the exposure values, and can be referred to as priming images. Light measurement in the first direction is performed by the imaging units 102, 202 and 302, whereas light measurement in the second direction is performed by the light meter 106, the second imaging unit 206 or the second imaging unit 306. The first direction and the second direction may be opposite against each other.

In operation S802, determining that a lighting condition is backlit is determined using a first photometric value, calculated by measuring light in the first direction, and a second photometric value calculated by measuring light in the second direction. In one example, whether a lighting condition is backlit is determined using the method of FIG. 8, but aspects of the present invention are not limited thereto. According to the result of operation S802, the following operation of operation S803 is determined.

If it is determined in operation S803 that the imaging units 102, 202 and 302 are in a backlit condition, the exposure compensation method according to the exemplary embodiments of the present invention is utilized. An exposure value to be used by the imaging units 102, 202 and 302 to photograph an image is calculated using the second photometric value is calculated in operation S801, and then the calculated exposure value is set to be an exposure value of the imaging units 102, 202 and 302 in operation S804. As described above, operation S804 may be performed by the control units 110, 210 and 310 or by the imaging units 102, 202 and 302. Here, the control units 110, 210 and 310 or the imaging units 102, 202 and 302 may consider the exposure value calculated in operation S801 as an exposure value of the imaging units 102, 202 and 302, and then set the exposure value calculated in operation S801 to be an exposure value of the imaging units 102, 202 and 302. However, aspects of the present invention are not limited thereto, so the imaging units 102, 202 and 302 may determine an exposure value by reflecting the second photometric value to the first photometric value.

In operation S805, an image is captured by the imaging units 102, 202 and 302 at the exposure value set in operation S804, and the image processing units 108, 208 and 308 generate image data by processing the image. There is no specific limitation on how to apply an exposure value, when an image is captured by the imaging units 102, 202 and 302. For example, an exposure value may be applied by adjusting a size of aperture, by adjusting a shutter speed, by adjusting ISO sensitivity or using two or more of the above-mentioned three ways.

If it is determined in operation S803 that the imaging units 102, 202 and 302 are not in a backlit condition, an exposure value is set using an existing method. In more detail, an exposure value to be used by the imaging units 102, 202 and 302 to photograph an image is calculated using the first photometric value calculated in operation S801, and then the calculated exposure value is set to be an exposure value of the imaging units 102, 202 and 302 in operation S806. Operation S806 may be performed by the imaging units 102, 202 and 302. Next, an image is captured by the imaging units 102, 202 and 302 at the exposure value set in operation S806, and then the image processing units 108, 208 and 308 generate image data by processing the is image in operation S807. As described above, there is no specific limitation on how to apply an exposure value, when an image is captured by the imaging units 102, 202 and 302.

FIG. 11 is a flow chart illustrating an imaging method according to exemplary embodiments of the present invention. The imaging method illustrated in FIG. 11 is to photograph an image using the exposure compensation method of the present invention adaptively according to user environment settings. An image may be photographed by adaptively applying backlight determination and/or backlight compensation may be performed according to user environment settings. That is, before photography, a user may set user environment settings to automatically perform backlight compensation (hereinafter, referred to as an ‘automatic mode’), to not perform backlight compensation at all (hereinafter, referred to as a ‘manual mode’), or to automatically determine whether a lighting condition is backlit and determine whether to compensate an exposure value according to a selection of the user (hereinafter, referred to as a ‘semi-automatic mode’.

Referring to FIG. 11, an imaging apparatus or a camera function of an electronic device is executed in operation S901. If a camera operates according to a result of operation S901, the imaging apparatus checks user environment settings for backlight compensation in operation S902. Checking the user environment settings may be performed by a control unit which is included in the imaging apparatus. In addition, the user environment settings may be stored as being set in a specific mode (for example, an automatic mode, a manual mode, and a semi-automatic mode) by a user of the imaging apparatus or the electronic device, or to be set in a specific default mode.

If the user environment settings are set to be in an automatic mode according to the result of operation S902, backlight determination and exposure compensation are always is performed to photograph an image in S903. In the backlight determination in operation S903, the method for determining a backlit condition in FIG. 6 or FIG. 8 may be utilized. In addition, the exposure compensation in operation S903, the exposure compensation method in FIG. 4 or an exposure compensation process included in the imaging method in FIG. 9 or FIG. 10 may be employed. If the user environment settings are set to be in a manual mode according to the result of operation S902, backlight determination and exposure compensation may not be performed to photograph an image in operation S909.

If the user environment settings are set to be in a semi-automatic mode according to the result of operation S902, backlight determination is automatically performed, but whether to perform exposure compensation is determined by a user in the backlit condition. That is, although a lighting condition is backlit, exposure compensation is performed only upon a user's request. In more detail, whether a lighting condition is backlit is determined in operation S904. Next, if it is determined in operation S904 that the lighting condition is backlit, a question about whether to perform backlight compensation or an execution menu of backlight compensation is displayed in operation S905. However, if it is determined in operation S904 that the lighting condition is not backlit, an image is photographed without setting a new exposure value. Next, whether a user selects the question or menu displayed in operation S905 to perform backlight compensation or whether the user inputs an instruction to perform backlight compensation is determined in operation S906. If it is determined in operation S906 that the user selects the question or menu to perform backlight compensation or that the user inputs the instruction to perform backlight compensation, an image is photographed with setting a new exposure value in operation S907. However, if it is determined in operation S906 that the user does not select the question or menu to perform backlight compensation or the user does not input the instruction to is perform backlight compensation, an image is photographed without setting a new exposure value in operation S908.

According to the above exemplary embodiments of the present invention, light measurement in a direction, different from a direction in which an object is located, is performed, and an exposure value is calculated using the resultant photometric value to photograph an image, thereby preventing the object from not being properly photographed in a specific lighting condition, for example, in a backlit condition. According to exemplary embodiments of the present invention, light measurement is performed in a backlit condition with respect to reflected light, and an exposure value to be used for photographing an image is calculated based on the resultant photometric value. Accordingly, an exposure value suitable for the surroundings of an object may be used.

In some embodiments, whether a lighting condition is backlit is determined using an average luminance value of an image captured by the light meter and a ratio between average luminance values of two-type areas, one area having an average luminance value less than the average luminance value of the image and the other area having an average luminance value greater than the average luminance value of the image. In some embodiments, whether a lighting condition is backlit is determined using a ratio between two photometric values calculated with respect to two directions, each direction corresponding to a different incident direction of light. For this reason, a process used in determining whether a lighting condition is backlit may be determined with higher accuracy.

In some embodiments, exposure compensation utilizes the photometric values calculated with respect to two directions, each direction corresponding to a different incident direction of light, and the exposure compensation is performed automatically to photograph an image. In some embodiments, exposure compensation can be performed automatically without a user's manipulation or instruction, without requiring post-processing on image data of a photographed image.

The exemplary embodiments of the present invention may be realized using computer-readable codes in a computer-readable recording medium. The computer-readable recording medium includes all types of non-tangible recording media that store computer-system readable data.

Examples of the computer-readable recording medium includes a Read Only Memory (ROM), a Random Access Memory (RAM), a CD-ROM, a magnetic tape, a floppy disk and an optical data storage device, and the computer readable recording medium may be realized in a carrier wave form (for example, transition via the Internet). In addition, the computer-readable recording medium is distributed in a computer system connected via a network so that computer-readable codes are stored and executed in a distributed manner. In addition, functional programs, codes and code segments used to embody the present invention may be easily anticipated by programmers in the technical field of the present invention.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An imaging apparatus comprising:
a body;
an imaging unit installed in the body and configured to photograph an image of an object to be photographed in a first direction;
an image processing unit configured to generate image data by processing the image;
a light meter installed in the body and configured to measure light in a second direction corresponding to an incident direction of light different from an incident direction of light of the first direction; and
a control unit configured to control the imaging unit to photograph the image at an exposure value calculated using a photometric value based on the light measured by the light meter.

2. The imaging apparatus of claim 1, wherein the object is backlit and the control unit determines that the object is backlit by using an average luminance value of an image captured by the light meter, and a ratio between average luminance values of a first area and a second area, the first area having an average luminance value less than the average luminance value of the image and the second area having an average luminance value greater than the average luminance value of the image.

3. The imaging apparatus of claim 1, wherein the object is backlit and the control unit determines that the object is backlit by using a ratio between a first photometric value calculated with respect to the first direction and a second photometric value calculated with respect to the second direction.

4. The imaging apparatus of claim 1, wherein the body includes a first surface where the imaging unit is installed and a second surface facing a direction opposite the first surface, and the imaging apparatus further comprises:
a second imaging unit installed on the second surface, wherein the second imaging unit includes the light meter.

5. The imaging apparatus of claim 4, wherein the image processing unit comprises a first image processing unit configured to generate the image data by processing the image from the imaging unit, and the imaging apparatus further comprises a second image processing unit configured to generate image data by processing a second image from the second imaging unit.

6. The imaging apparatus of claim 5, wherein the control unit is configured to operate the first imaging unit and the second imaging unit substantially simultaneously.

7. The imaging apparatus of claim 1, wherein the control unit is configured to operate the light meter a short duration before operating the imaging unit.

8. The imaging apparatus of claim 1, wherein the control unit is configured to check a user environment setting to either photograph the image based on the calculated exposure value, or based on a user input of a backlight exposure value.

9. A method for determining a backlit condition, the method comprising:
photographing an image of an object in a first direction with an imaging unit installed in a body;
generating image data by processing the image;
measuring light, with a light meter installed in the body, in a second direction corresponding to an incident direction of light different from an incident direction of light of the first direction; and
calculating an exposure value, with a processor, using a photometric value based on the light measured by the light meter,
wherein the photographing by the image unit is based on the exposure value.

10. The method of claim 9, wherein the object is backlit and the method further comprises determining that the object is backlit by using an average luminance value of an image captured by the light meter, and a ratio between average luminance values of a first area and a second area, the first area having an average luminance value less than the average luminance value of the image and the second area having an average luminance value greater than the average luminance value of the image.

11. The method of claim 9, wherein the object is backlit and the method further comprises determining that the object is backlit by using a ratio between a first photometric value calculated with respect to the first direction and a second photometric value calculated with respect to the second direction.

12. The method of claim 9, wherein the body includes a first surface where the imaging unit is installed and a second surface facing a direction opposite the first surface, and the imaging apparatus further comprises a second imaging unit installed on the second surface, wherein the second imaging unit includes the light meter.

13. The method of claim 12, wherein the generating further comprises generating second image data by processing a second image from the second imaging unit.

14. The method of claim 13, further comprising operating the first imaging unit to photograph the image and the second imaging unit to measure the light substantially simultaneously.

15. The method of claim 9, wherein the measuring is performed a short duration before operating the imaging unit.

16. The method of claim 9, further comprising checking a user environment setting to either photograph the image based on the calculated exposure value, or based on a user input of a backlight exposure value.

17. An imaging apparatus comprising:
a first imaging unit configured to capture a first image in a first direction;
a second imaging unit configured to capture a second image in a second direction; and
a control unit configured to control the first imaging unit to capture the first image at an exposure value calculated using a photometric value based on light incident to the first direction, wherein the incident light is measured in the second image,
wherein the second image is captured prior to the first image.

18. The imaging apparatus of claim 17, wherein a time elapse between the capture of the second image and the capture of the first image is less than 10 seconds.

19. The imaging apparatus of claim 17, wherein the first direction is substantially diametrically opposite the second image.

20. The imaging apparatus of claim 17, wherein the control unit is configured to capture a priming image using the first imaging unit, configured to determine if an object in the priming image is backlit, and configured to use the calculated exposure value in capturing the first image when the object is backlit.

21. The imaging apparatus of claim 17, wherein the control unit is configured to capture a priming image using the first imaging unit, configured to determine if an object in the priming image is backlit, configured to calculate a second exposure value based on incident light in the priming image, and configured to capture the first image using the second exposure value when the object is not backlit.
